(19) United States
(12) Patent Application Publication
(10) Pub. No.: US 2026/0080888 A1
(43) Pub. Date: Mar. 19, 2026

(54) VOICE TRANSFORMATION FOR THROAT MICROPHONES

(71) Applicant: Intel Corporation, Santa Clara, CA (US)

(72) Inventors: Hector Alfonso Cordourier Maruri, Guadalajara (MX); Julio Cesar Zamora Esquivel, West Sacramento, CA (US); Paulo Lopez Meyer, Zapopan (MX); Alejandro Ibarra Von Borstel, Buda, TX (US); Leobardo Campos Macias, Guadalajara (MX); Margarita Jauregui Franco, Japopan (MX); Rodrigo Aldana Lopez, Zapopan (MX); Edgar Macias Garcia, Zapopan (MX); Georg Stemmer, Munich (DE); Nathan Mataya, Houston, TX (US); Priyanka Dhage, Cedar Park, TX (US); Johan Rivera, Tempe, AZ (US); Karla Cruz-Lee, Tucson, AZ (US); Saran Poovarodom, Beaverton, OR (US)

(73) Assignee: Intel Corporation, Santa Clara, CA (US)

(21) Appl. No.: 19/396,111

(22) Filed: Nov. 20, 2025

(51) Int. Cl. G10L 21/057; G10L 21/0216; G10L 21/0224; G10L 21/0232; G10L 25/18; G10L 25/30; H04R 1/46; H04R 3/00

(52) U.S. Cl. CPC G10L 21/057; G10L 21/0224; G10L 21/0232; G10L 25/18; G10L 25/30; H04R 1/46; H04R 3/005; G10L 2021/02165; H04R 2410/05

(57) ABSTRACT

Systems and methods are provided for transforming audio signals captured by a throat microphone into signals emulating speech recorded with a conventional air-conduction microphone. Throat microphones employ vibration sensors positioned on the neck to capture audio, making them suitable for high-noise environments. However, throat microphone signals lack high-frequency components, reducing intelligibility and degrading automatic speech recognition performance. The techniques provided herein apply signal-processing operations and a lightweight neural network to reconstruct missing spectral details. The input signal is converted to log-Mel spectra and modeled as a smooth average spectrum (SAS) plus a residual component. A neural network predicts a conventional-microphone SAS. A vocoder synthesizes an enhanced audio signal after combining the predicted SAS with the residual component. The approach improves speech intelligibility and ASR accuracy while maintaining low computational complexity, enabling real-time, on-device processing in noisy environments and supporting hands-free communication for applications such as collaborative robotics and augmented reality.

### TECHNICAL FIELD

This disclosure relates generally to throat microphones, and in particular to voice transformation based on smooth average spectra for throat microphones.

### BACKGROUND

Throat microphones are specialized audio devices that capture sound vibrations directly from the user's throat rather than through airborne sound waves. Throat microphones are a commercially available alternative to regular microphones. In noisy environments, throat microphones can help minimize background noise and provide clear voice transmission. However, the captured signal often lacks high-frequency components, which can reduce intelligibility for listeners and negatively impact the performance of automatic speech recognition systems. In general, throat microphones have reduced audio fidelity compared to traditional microphones, making them less ideal for natural-sounding speech or music.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 shows a voice transformation system for transforming a throat microphone signal 105, according to various embodiments.

FIGS. 2A and 2B illustrate spectrograms of an audio signal recorded using a regular microphone and using a throat microphone, according to various embodiments.

FIG. 3 illustrates an example of a spectrum from an audio signal received from a microphone, according to various embodiments.

FIG. 4 illustrates a block diagram of an example system for voice transformation of throat microphone signals into audio signals that emulate speech recorded using conventional microphones, in accordance with various embodiments.

FIG. 5 illustrates an example of a mapping neural network, in accordance with various embodiments.

FIG. 6 illustrates an example pipeline for training a neural network to transform throat microphone signals into audio signals that emulate speech recorded using conventional microphones, in accordance with various embodiments.

FIG. 7 illustrates a table showing the word error rate (WER) performance for English and Spanish speech recognition tasks under three different input conditions, in accordance with various embodiments.

FIGS. 8A-8C illustrate examples of spectrograms of an audio file including speech, in accordance with various embodiments.

FIG. 9 illustrates a method that can be used for a voice transformation system based on smooth average spectra for throat microphones, in accordance with various embodiments.

FIG. 10 is a block diagram of an example deep learning system, in accordance with various embodiments.

FIG. 11 is a block diagram of an example computing device, in accordance with various embodiments.

### DESCRIPTION

### Overview

Systems and methods are provided for transforming the captured signal from a throat microphone to make the signal more intelligible. Throat microphones use a vibration sensor positioned on the neck to capture audio signals directly from skin contact, effectively ignoring airborne audio interference. Thus, throat microphones can be useful in noise environments. However, the signals captured by throat microphones often lack high-frequency components, which can reduce intelligibility for human listeners. Additionally, the absence of high-frequency information can degrade the accuracy of Automatic Speech Recognition (ASR) systems, which often rely on a full spectrum of frequencies to correctly interpret and transcribe speech.

To mitigate the limitations associated with throat microphones, one approach involves acquiring a substantial corpus of voice recordings captured via throat microphone sensors, accompanied by corresponding transcriptions. The data may be utilized to develop acoustic models for a new ASR engine or to fine-tune existing models. However, this methodology presents significant practical challenges, as it necessitates the collection and annotation of hundreds or thousands of hours of speech from a diverse population of speakers. Furthermore, the process must be repeated for each target language, thereby increasing cost and resource usage.

Another approach to address the limitations of throat microphones is to instead use conventional microphones with sophisticated audio noise reduction algorithms. Advanced noise reduction techniques, particularly those employing artificial intelligence, can achieve satisfactory performance with conventional microphones under challenging acoustic conditions. However, these techniques are typically computationally intensive and therefore unsuitable for processing directly on local devices. The algorithms generally depend on cloud-based resources to enable near real-time operation. This dependency significantly constrains the applicability of the audio noise reduction algorithms in scenarios requiring immediate, on-device processing.

According to various implementations, a voice transformation technique is provided that converts a raw signal acquired from one or more throat-mounted sensors into a signal that approximates the output of an air-conduction microphone. The transformation utilizes signal-processing operations in combination with a lightweight neural network, thereby enhancing ASR performance and improving intelligibility for human-to-human communication.

In particular, in some implementations, the raw throat-microphone waveform is segmented into multiple frames, and each frame is converted to the frequency domain. In some examples, each frame is converted to the frequency domain using a log-Mel spectrum. Each spectrum can be modeled as the sum of a Smooth Average Spectrum (SAS) and a deviation (residual) component. A lightweight neural network is trained to map the SAS derived from the throat-microphone input to a corresponding SAS representative of a conventional microphone. In some examples, the neural network includes gated recurrent unit (GRU) layers and fully connected layers. During runtime (i.e., inference), the neural network predicts the conventional-microphone SAS from the throat-microphone input, and a vocoder reconstructs an enhanced audio signal by combining the predicted SAS with the original deviation component.

The systems and methods presented herein balance computational efficiency and performance. In contrast to conventional approaches that require extensive data acquisition from throat-mounted sensors to construct specialized acoustic models, the techniques discussed herein leverage existing datasets to emulate the signal characteristics of a conventional microphone, thereby ensuring compatibility with established ASR systems. The computational requirements are minimal, as the proposed neural network is trained on a simplified sub-product of the raw input signal. The effectiveness of the approach is attributable to the processing of spectrum frames, which can be efficiently managed input features for the neural network. The techniques provided herein enhance the audio quality and functional capabilities of throat microphones, and thereby address the increasing demand for hands-free communication and integration with emerging platforms such as augmented reality technology.

In some examples, the systems and methods provided herein can be used in the design and validation of robotic systems intended to operate in conjunction with technicians and engineers within semiconductor fabrication facilities (Fabs). The robotic systems can augment technician capabilities by delegating repetitive and physically demanding tasks to robotic systems, thereby enabling personnel to concentrate on advanced diagnostic and problem-solving activities. Collaborative robots represent an emerging global trend in silicon manufacturing environments, and the techniques provided herein form an integral component of the final product architecture. In particular, in current Fab and datacenter environments, ambient noise levels frequently reach or exceed 90 dB. The adoption of throat-mounted microphones allows for communication in such noisy environments. Additionally, throat microphones are compatible with protective garments, such as bunny suits, and other head-worn equipment that can impede the use of conventional headset microphones.

For purposes of explanation, specific numbers, materials, and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” or the phrase “A or B” means (A), (B), or (A and B). For the purposes of the present disclosure, the phrase “A, B, and/or C” or the phrase “A, B, or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or systems. Also, the term “or” refers to an inclusive “or” and not to an exclusive “or.”

The systems, methods, and devices of this disclosure each have several innovative aspects, no single one of which is solely responsible for all desirable attributes disclosed herein. Details of one or more implementations of the subject matter described in this specification are set forth in the description below and the accompanying drawings.

### Example Voice Transformation System for a Throat Microphone

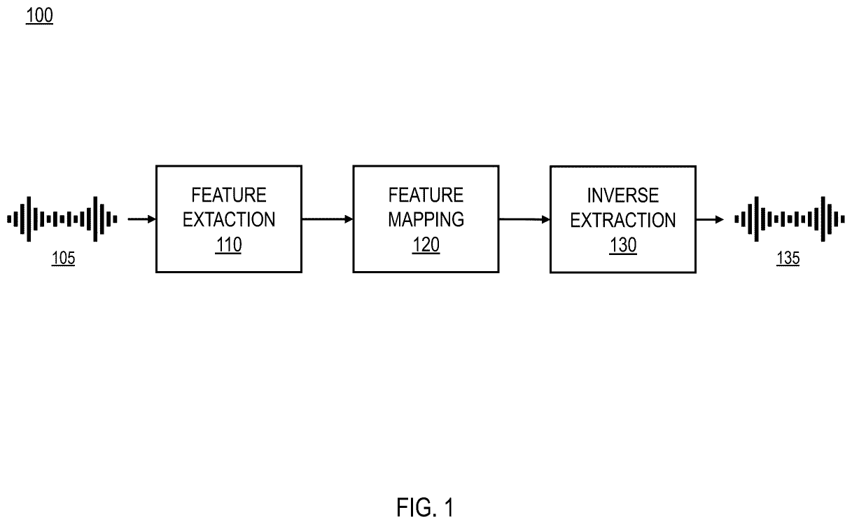

FIG. 1 shows a voice transformation system 100 for transforming a throat microphone signal 105, according to various embodiments. In particular, a throat microphone signal 105 is input to a feature extraction module 110.

The feature extraction module 110 converts the raw time-domain audio signal captured by the throat microphone 105 to a frequency-domain representation. In some examples, the continuous audio signal is divided into overlapping time frames (e.g., 64 ms windows with a 10 ms hop). Each time frame is transformed from the time domain to the frequency domain. In some examples, a Short-Time Fourier Transform (STFT) can be used to convert each time frame to the frequency domain. A frequency-domain spectrum can be generated for each time frame. A frequency-domain spectrum can show energy distribution of the signal across different frequencies. The frequency-domain spectrum can be mapped to a Mel scale and converted to a logarithmic amplitude scale, resulting in a Log-Mel spectrum for each time frame.

For each Log-Mel spectrum, the feature extraction module 110 determines a SAS and a deviation (also called a ripple deviation, and/or a spectrum residual). The SAS for each spectrum can be determined by applying a smoothing operation (e.g., a moving average) across the Mel frequency bins. The spectrum residual can be determined by subtracting the SAS from the original Log-Mel spectrum. According to various examples, the SAS captures the broad spectral envelope, while the spectrum residual captures fine spectral details. The extracted features from the feature extraction module 110 are input to a feature mapping module 120.

The feature mapping module 120 can be a neural network, such as a recurrent neural network. The feature mapping module 120 converts the spectral characteristics of the throat microphone signal 105 to a form that resembles an air-conducted microphone signal. In particular, the feature mapping module receives the Smooth Average Spectra generated by the feature extraction module 110. The feature mapping module 120 maps the SAS received from the feature extraction module 110 to a corresponding estimated SAS from a conventional microphone. In some examples, the feature mapping module 120 outputs the estimated SAS from a conventional microphone.

According to various implementations, the feature mapping module 120 is a lightweight and efficient neural network. In some examples, the feature mapping module is neural network including at least one gated recurrent unit (GRU) layer and at least one fully connected layer. In some examples, the feature mapping module is a neural network including multiple GRU layers and multiple fully connected layers. In some examples, the feature mapping module is a neural network including five GRU layers and five fully connected layers. The GRU layers can be used by the neural network to model temporal dependencies across sequential audio frames, thereby capturing the dynamics of speech. In some examples, the GRU layers are used by the model to predict missing high frequency content.

The output from the feature mapping module 120, the estimated SAS from a conventional microphone for each time frame, is the input to the inverse extraction module 130. The inverse extraction module 130 combines the estimated SAS with the corresponding spectrum residual from the feature extraction module 110 to reconstruct a complete full-band Log-Mel spectrum. In some examples, the inverse extraction module 130 sums the complete Log-Mel spectrum and the spectrum residual to generate the reconstructed spectrum. Thus, the inverse extraction module 130 generates a reconstructed spectrum that includes both the broad spectral envelope (from the estimated SAS) and the fine spectral details (from the spectrum residual). In various examples, the reconstructed spectrum closely matches a spectrum that would be generated from a signal recorded from a regular microphone.

The reconstructed Log-Mel spectrum can be converted back to a linear-frequency power spectrum by applying the inverse Mel transformation and exponentiating (to reverse the logarithmic scaling). A vocoder can be used to synthesize a time-domain audio waveform from the reconstructed power spectrum. In some examples, the vocoder can fill in missing phase information, and in some examples, the vocoder can generate a continuous audio signal. The audio signal can be output audio signal 135, which can be played back, transmitted, and/or processed by downstream systems. In some examples, the output audio signal can be used for human-to-human communications in a noisy environment. In some examples, the output audio signal 135 can be used by an automatic speech recognition system.

In various implementations, the feature mapping module 120 includes a neural network that can be trained to generate the estimated SAS. For example, the neural network can be trained using paired data, with one element of a pair including an SAS from a throat microphone and the other element of a pair including an SAS from a regular microphone. During training, the network minimizes the difference between its predicted output SAS and the target conventional-microphone SAS.

### Example Throat Microphone Signal Spectrogram and Spectrum

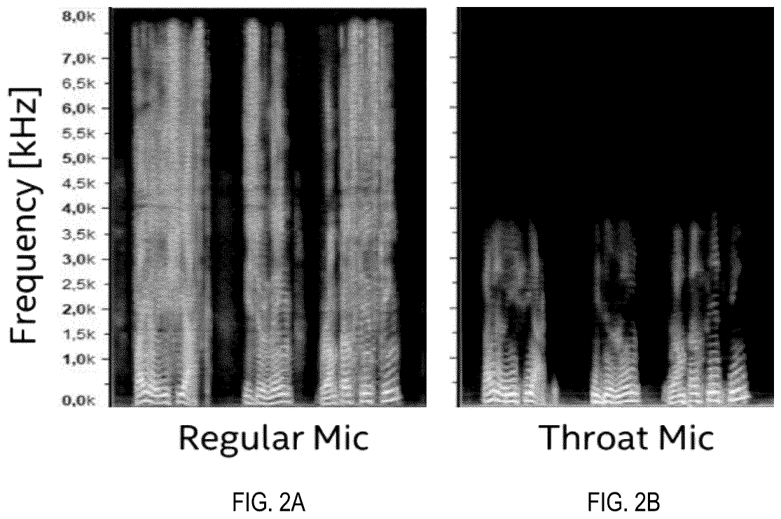

FIGS. 2A and 2B illustrate spectrograms of an audio signal recorded using a regular microphone and using a throat microphone, according to various embodiments. The spectrograms illustrate the different frequency content of the audio signals captured by each type of microphone. As shown in FIG. 2B, the signal acquired by the throat microphone frequently lacks high-frequency components relative to the signal captured by a conventional air-conducted microphone. This loss of high-frequency information can impact the intelligibility of speech and the performance of automatic speech recognition systems. Throat microphones often exhibit a higher word error rate compared to regular microphones, not due to interfering noise, but because of the absence of the high frequency components.

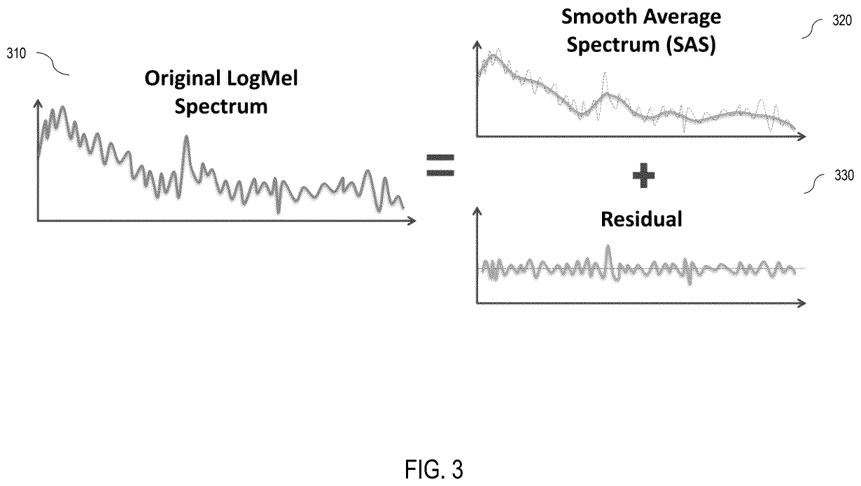

FIG. 3 illustrates an example of a spectrum from an audio signal received from a microphone, according to various embodiments. The microphone can be a regular microphone, a throat microphone, or any other selected type of microphone. As previously described, the input audio signal in the time domain may be segmented into a plurality of fixed-length frames. Each frame can be transformed into the frequency domain using a selected transform, such as a STFT. Based on the frequency-domain representation of each frame, a corresponding power spectrum 310 can be determined for each time frame. In some embodiments, the power spectrum 310 is expressed on a Log-Mel scale. In various examples, the Log-Mel scale can provide dimensionality reduction properties when used in audio processing tasks involving machine learning and/or deep neural networks. Each Log-Mel power spectrum 310 may be modeled as a composite of two components: a Smooth Average Spectrum (SAS) 320 and a ripple deviation 330 (also referred to as a spectral residual). The decomposition of the power spectrum 310 into the SAS 320 and the ripple deviation 330 facilitates the isolation of fine-grained spectral variations from the underlying smooth spectral envelope.

The SAS 320 may be derived by applying a moving average or other smoothing function to the logarithmic representation of the original spectrum (expressed in decibels). The ripple deviation 330 is determined by subtracting the SAS 320 from the original Log-Mel power spectrum 310, thereby capturing localized spectral fluctuations that may correspond to speech characteristics.

In some embodiments, simultaneous recordings can be obtained from both a conventional air-conduction microphone and a throat-mounted sensor to enable the generation of paired SAS profiles and ripple deviations for each microphone source. The paired SAS profiles and ripple deviations can be used for training a neural network. In some examples, the paired SAS profiles and ripple deviations can be used to provide a framework for comparative analysis, fusion, and/or feature extraction, which can be used for downstream tasks such as speech recognition, speaker identification, and/or noise suppression.

### Example Voice Transformation System and Neural Network

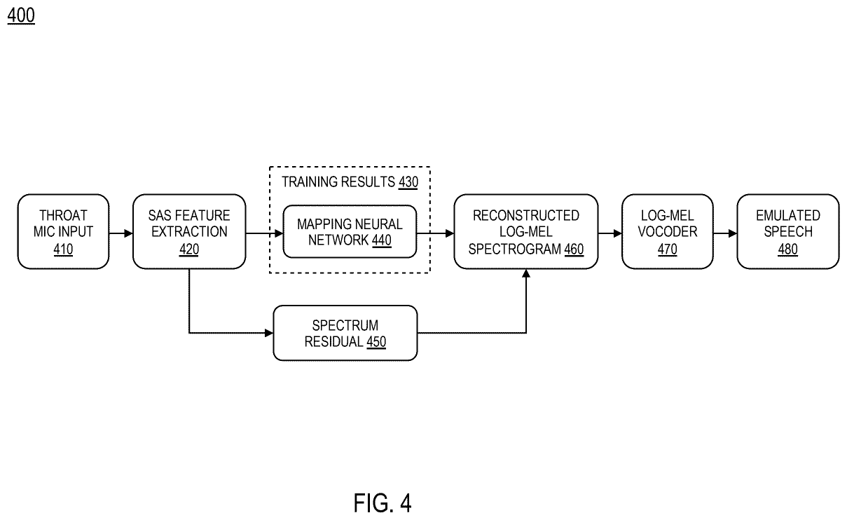

FIG. 4 illustrates a block diagram of an example system 400 for voice transformation of throat microphone signals into audio signals that emulate speech recorded using conventional microphones, in accordance with various embodiments.

Throat microphone input 410 can include signals captured from a throat microphone, including raw vibration-based audio signals from a speaker's throat. In some examples, the throat microphone signals are captured using a sensor positioned on the speaker's neck. The throat microphone signals are processed at a SAS feature extraction block 420. The SAS feature extraction block extracts SAS features that represent the spectral characteristics of the throat microphone signal. In particular, the SAS features capture the spectral envelope of the throat microphone input 410 while smoothing out noise and irregularities. In some examples, the SAS features extracted at the SAS feature extraction block 420 can include a robust representation of speech characteristics.

In some examples, the SAS feature extraction block 420 segments the throat microphone signal into overlapping frames using a fixed-length window with a selected overlap. A windowing function such as a Hamming function, a Hann function, or other function can be applied to each frame. In some examples, the windowing function can minimize spectral leakage during analysis. A Fast Fourier Transform (FFT) spectral analysis can be applied to each frame to determine a frequency-domain representation of each frame, and each frame can be represented by a magnitude spectrum that captures the energy distribution across frequencies for the respective frame. Frame level averaging (e.g., averaging spectra from multiple consecutive frames) can be used to reduce variability that can be caused by throat microphone inconsistencies and environmental noise. Frame level averaging results in a smooth spectral envelope that emphasizes stable spectral characteristics while suppressing noise. As discussed above, the extracted SAS features focus on low frequency bands, since throat microphones do not record high frequency details. In some examples, the SAS feature extraction block 420 normalizes the smoothed spectral features using, for example, log compression or mean-variance normalization. The normalized SAS features extracted by the SAS feature extraction block 420 can be used to generate an input vector for input to the mapping neural network 440.

The SAS feature extraction block 420 outputs the extracted SAS features to the mapping neural network. Additionally, the SAS feature extraction block 420 outputs a spectrum residual component 450, which is used in reconstructing the signal following processing by the mapping neural network 440.

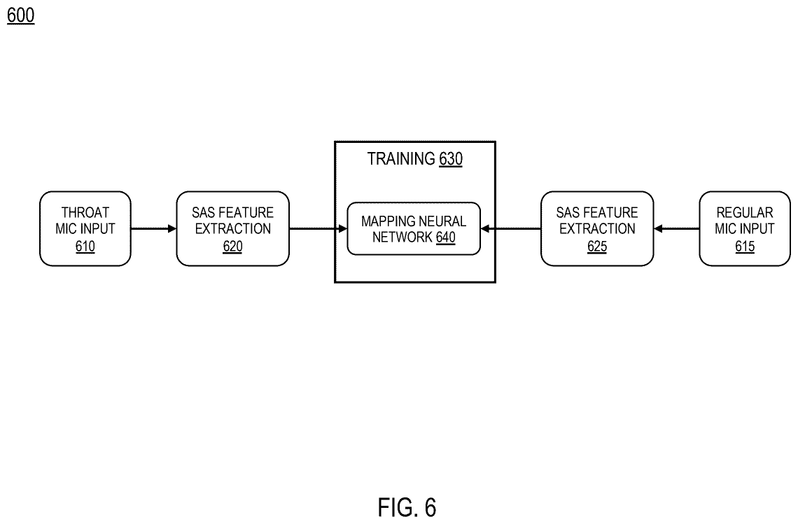

The mapping neural network 440 receives the SAS features extracted at the SAS feature extraction block 420, and generates a reconstructed log-Mel spectrogram 460. In some examples, the mapping neural network 440 reconstructs missing high frequency components of the recorded speech that are absent from throat microphone input 410. Thus, in some examples, the reconstructed log-Mel spectrogram 460 is based on the SAS features plus the missing high frequency components of the speech signal. In some implementations, the mapping neural network 440 maps input SAS features to corresponding estimated SASs from a conventional microphone to generate the reconstructed log-Mel spectrogram 460. The mapping neural network 440 can be trained to generate a reconstructed log-Mel spectrogram 460 from the input SAS features, as described herein, for example with respect to FIG. 6.

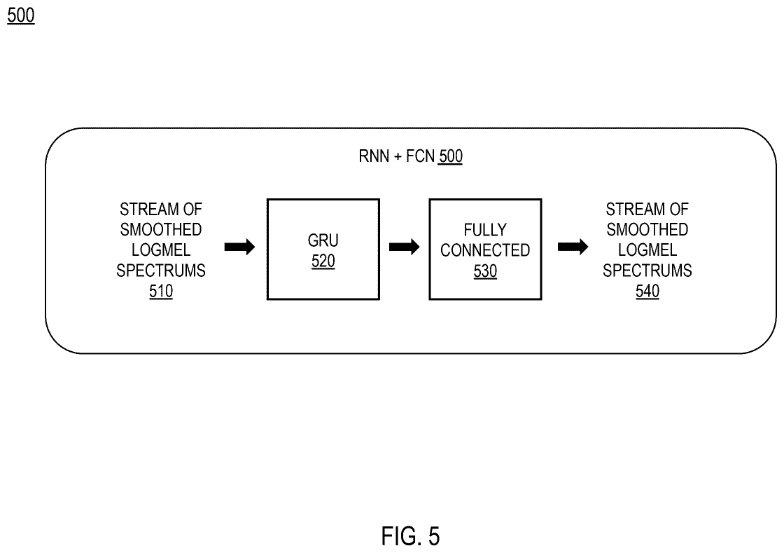

In some examples, the mapping neural network 440 can be a regression neural network. In some examples, the mapping neural network 440 can include one or more GRU recursive layers and one or more fully connected layers. The mapping neural network 440 is a lightweight neural network that can be implemented on a device and can generate the output emulated speech 480 in real time. In some examples, the mapping neural network 440 can be a transformer-based model. In some examples, the mapping neural network 440 can include a convolution and recurrent hybrid model. An example implementation of a regression neural network 440 is shown in FIG. 5 and discussed herein.

The mapping neural network 440 outputs a reconstructed log-Mel spectrogram 460, and the spectrum residual 450 is added to (or fused with) the reconstructed log-Mel spectrogram 460 to enhance and/or refine the reconstructed log-Mel spectrogram 460. The spectrum residual 450 can provide corrective spectral information that enhances the fidelity of the reconstructed log-Mel spectrogram 460. In some examples, the spectrum residual 450 is combined with the reconstructed log-Mel spectrogram 460 using additive fusion, which can include simple element-wise addition. In some examples, the spectrum residual 450 is combined with the reconstructed log-Mel spectrogram 460 using gated fusion, which can include a weighted combination of elements.

The reconstructed log-Mel spectrogram 460 can be processed by a log-Mel vocoder 470. The log-Mel vocoder can synthesize an audio waveform from the spectrogram representation. The vocoder 470 output is converted into emulated speech 480, which approximates natural speech recorded with a conventional microphone. According to various examples, the emulated speech 480 can be used to improve intelligibility of throat microphone signals for both human listeners and for speech recognition systems.

FIG. 5 illustrates an example of a mapping neural network 500, in accordance with various embodiments. The mapping neural network 500 can be used to transform a stream of input log-Mel spectra 510 based on a throat microphone input signal (e.g., from a SAS feature extraction block 420) to a stream of output log-Mel spectra 540 that correspond with log-Mel spectra from a conventional air-conduction microphone of the same input signal. According to various implementations, the mapping neural network 440 discussed with respect to FIG. 4 can be the mapping neural network 500.

The mapping neural network 500 includes two primary stages: a recurrent processing stage 520 and a fully connected stage 530. In some examples, the recurrent processing stage 520 is implemented as a GRU network. In some examples, the recurrent processing stage 520 is implemented as a multi-layer GRU network, for instance, a 5-layer GRU network. In some examples, the recurrent processing stage 520 is implemented as a multi-layer GRU recursive step. In some examples, the fully connected stage 530 includes multiple fully connected layers. For example, the fully connected stage 530 can include five dense layers.

The recurrent processing stage 520 can capture temporal dependencies inherent in sequential audio data. In some examples, temporal dependencies across frames can include phonetic context, coarticulation, and prosody. In some examples, the recurrent processing stage 520 generates a sequence of context-enriched hidden states. By capturing the temporal dependencies, the model can incorporate contextual information across time frames. According to some examples, temporal modeling (i.e., capturing the temporal dependencies) enables the mapping neural network 500 to reconstruct high-frequency components of the audio data that are absent or attenuated in the throat microphone input.

The fully connected stage 530 performs nonlinear mapping from the extracted features to the target spectrogram representation, ensuring accurate reconstruction of spectral details. In particular, the fully connected stage 530 receives the output from the recurrent processing stage 520, including the context-enriched hidden states. The fully connected stage 530 can perform dense affine projection to transform the received input and convert the temporal representations generated by the recurrent stage 520 to frequency-domain targets at selected Mel bands. In some examples, the fully connected stage 530 includes multiple dense layers (e.g., 2-8 layers) with residual skip connections to increase capacity while keeping the recurrent depth minimal. The fully connected stage 530 outputs a stream of estimated output smooth log-Mel spectra 540 that correspond with log-Mel spectra from a conventional air-conduction microphone of the input signal from the throat microphone. In some examples, the output log-Mel spectra 540 can be combined with the spectrum residual produced during SAS feature extraction to generate a reconstructed log-Mel spectrogram, such as the reconstructed log-Mel spectrogram 460 of FIG. 4.

### Example Neural Network Training for a Voice Transformation System

FIG. 6 illustrates an example pipeline 600 for training a neural network to transform throat microphone signals into audio signals that emulate speech recorded using conventional microphones, in accordance with various embodiments. In particular, in selected implementations, a mapping neural network 640 is configured to transform throat microphone signals into audio signals that emulate speech received from conventional microphones. In some examples, the mapping neural network 640 is a recurrent neural network.

The mapping neural network 640 is trained using paired datasets including simultaneous recordings from a throat-mounted accelerometer-based microphone and a conventional air-conduction microphone. For each recording pair, the input signal 610 from the throat microphone is processed to extract SAS features 620 derived from the Log-Mel spectrogram. Similarly, SAS features 625 are extracted from the conventional microphone signal 615. The SAS features 625 extracted from the conventional microphone signal 615 serve as the ground truth target. In some examples, during training 630, the mapping neural network 640 learns a regression mapping between the throat microphone SAS features 620 and the corresponding conventional microphone SAS features 625. In some examples, the loss function may include mean squared error or other distance metrics applied to the predicted and target spectrograms. In some examples, the mapping neural network 640 is a recurrent neural network, and by leveraging the recurrent GRU layers, the mapping neural network 640 accounts for temporal continuity in speech. Using the temporary continuity of speech information, the mapping neural network 640 can predict the spectral components that are missing or distorted in the throat microphone input 610. Once trained, the mapping neural network 640 can infer a reconstructed Log-Mel spectrogram from throat microphone input 610, which, after adding its corresponding residual, is subsequently converted into audio using a vocoder, producing speech that closely resembles natural microphone-based recordings.

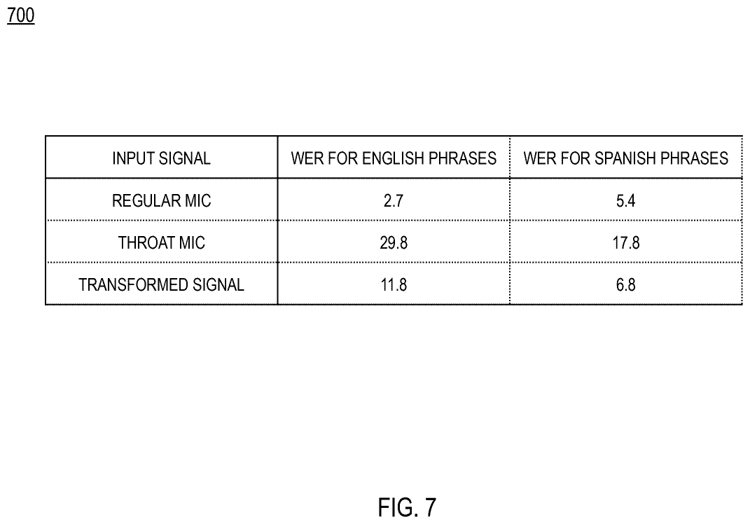

Examples of differences between word error rate using a regular microphone, using a throat microphone, and using the voice transformation system provided herein are shown in the table 700 of FIG. 7. In particular, the table 700 shows the word error rate (WER) performance for English and Spanish speech recognition tasks under three different input conditions, in accordance with various embodiments. The three different input conditions include a conventional air-conduction microphone (“Regular Mic”), a throat microphone (“Throat Mic”), and the enhanced signal generated by the voice transformation system presented herein (“Transformed Signal”).

As shown in the table 700, for English phrases, the conventional air-conduction microphone input yields a WER of 2.7%, while the throat microphone input results in a substantially higher WER of 29.8%. Application of the disclosed voice transformation system to the throat microphone signal reduces the WER to 11.8%, representing a significant improvement in recognition accuracy over the unprocessed throat microphone signal. Similarly, for Spanish phrases, the conventional air-conduction microphone input achieves a WER of 5.4%, the throat microphone input yields a WER of 17.8%, and the transformed signal produced by the present system achieves a WER of 6.8%. These results confirm that the disclosed system substantially narrows the performance gap between throat microphones and conventional microphones in automatic speech recognition tasks. Additionally, the results indicate that the transformation of throat microphone signals using the systems and methods presented herein generates enhanced speech signals that are more intelligible.

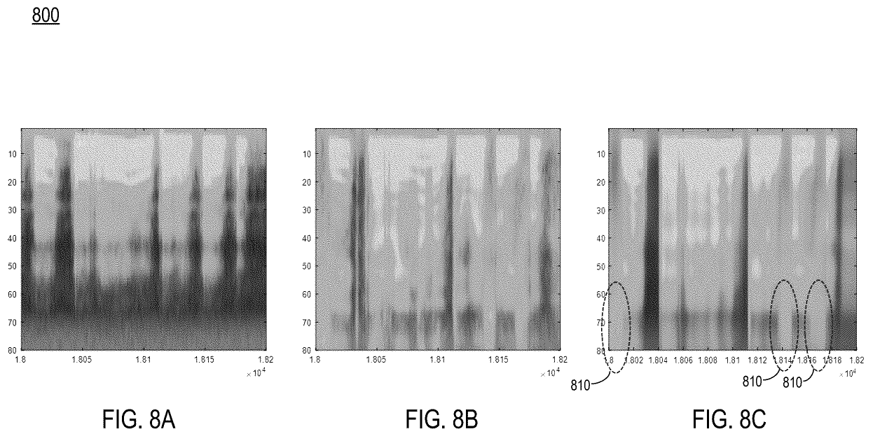

FIGS. 8A-8C illustrate examples of spectrograms of an audio file including speech, in accordance with various embodiments. In particular, FIGS. 8A-8C show comparative spectrograms of the same audio utterance. FIG. 8A shows a spectrogram of the audio file recorded using a throat microphone. FIG. 8B shows a spectrogram of the audio file recorded using a conventional air-conduction microphone. FIG. 8C shows output of the voice transformation system discussed herein when applied to the throat microphone signal represented in FIG. 8B. The spectrograms are presented in the log-Mel domain, with frequency on the vertical axis and time on the horizontal axis, and intensity is represented by lighter greys in the grayscale.

As shown in FIG. 8B, the spectrogram corresponding to the regular microphone signal exhibits a broad distribution of energy across both low and high frequency bands, including prominent high-frequency components above approximately 4 kHz. These high-frequency elements allow for the intelligibility of fricative and sibilant phonemes, such as /s/ and /∫/, and contribute to the naturalness and clarity of the speech signal. In contrast, as shown in FIG. 8A, the spectrogram derived from the throat microphone signal demonstrates a pronounced attenuation of high-frequency content, with energy largely confined to lower frequency bands. The absence of spectral energy above approximately 4 kHz is evident, reflecting the inherent low-pass filtering characteristic of throat microphones. This loss of high-frequency information results in diminished speech intelligibility and adversely affects the performance of automatic speech recognition systems.

FIG. 8C shows the spectrogram corresponding to the output of the voice transformation system discussed herein, which applies the neural network-based mapping and vocoder pipeline to the throat microphone signal. As shown in the spectrogram of FIG. 8C, the systems and methods presented herein result in substantial restoration of high-frequency components. The reconstructed spectrogram more closely resembles that of the regular microphone shown in FIG. 8B, with the reappearance of energy in the high-frequency bands and improved representation of phonetic detail. Some of these bands of high-frequency energy are indicated with dashed circles 810 in FIG. 8C. Thus, the voice transformation system effectively compensates for the spectral deficiencies of throat microphones, yielding an output signal that is more intelligible to human listeners and more compatible with state-of-the-art speech recognition engines.

### Example Method for Voice Transformation of Throat Microphone Signals

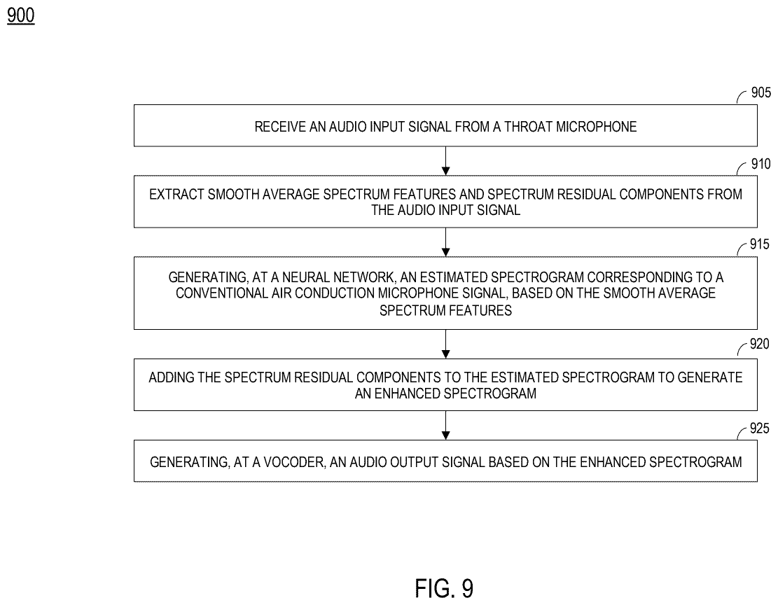

FIG. 9 illustrates a method 900 that can be used for a voice transformation system based on smooth average spectra for throat microphones, in accordance with various embodiments. In particular, the method 900 is an example method for transforming throat microphone signals into audio signals that emulate speech recorded using a conventional air-conduction microphone. Although the method 900 is described with reference to the flowchart illustrated in FIG. 9, many other methods for voice transformation may alternatively be used. For example, the order of execution of the elements in FIG. 9 may be changed. As another example, some of the steps may be changed, eliminated, or combined. In various examples, the method 900 can be implemented by a voice transformation system, such as the voice transformation system 100 of FIG. 1 or the voice transformation system 400 of FIG. 4.

At 905, an audio input signal is received from a throat microphone. In some examples, the audio input signal includes raw vibration-based audio captured by a sensor positioned on a speaker's neck. In some examples, the sensor can include an accelerometer.

At 910, SAS features and spectrum residual components are extracted from the audio input signal. The SAS features represent the spectral envelope of the throat microphone signal and are determined by segmenting the signal into overlapping frames, applying a windowing function (e.g., Hamming or Hann), obtaining a magnitude spectrum, and averaging across frames to reduce variability. In some examples, the extracted SAS features may be normalized. The spectrum residual component captures deviations from the smoothed spectral envelope.

At 915, the method 900 includes generating, at a neural network, an estimated spectrogram corresponding to a conventional air-conduction microphone signal, based on the smooth average spectrum features. In some examples, the neural network is a lightweight regression model comprising one or more GRU layers and one or more fully connected layers. The recurrent processing stage captures temporal dependencies across sequential frames, while the fully connected stage performs nonlinear mapping to produce an estimated log-Mel spectrogram that includes reconstructed high-frequency components absent from the throat microphone input.

At 920, the spectrum residual components are added to the estimated spectrogram to generate an enhanced spectrogram. In various examples, the spectrum residual components can be combined with the estimated spectrogram using additive fusion (element-wise addition) or gated fusion (weighted combination). In some examples, adding the spectrum residual components to the estimated spectrogram refines spectral details of the spectrogram and improves fidelity.

At 925, the method 900 includes generating, at a vocoder, an audio output signal based on the enhanced spectrogram. The vocoder synthesizes a time-domain waveform from the enhanced log-Mel spectrogram, producing emulated speech that approximates natural speech recorded with a conventional microphone. According to various examples, the audio output improves intelligibility for human listeners and enhances compatibility with speech recognition systems.

### Example Deep Neural Network System

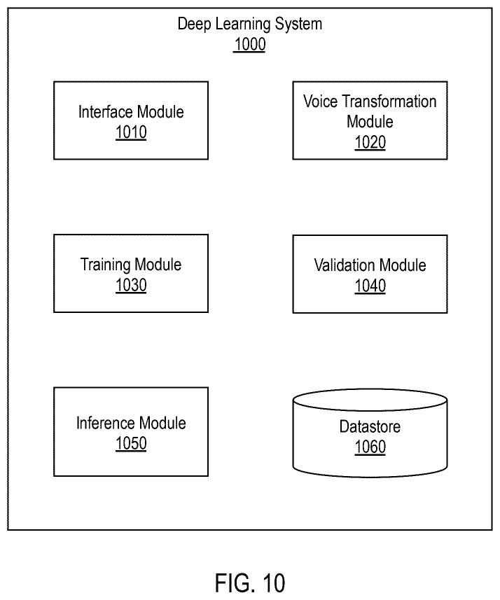

FIG. 10 is a block diagram of a deep learning system 1000 that can be used for a voice transformation system for throat microphones, in accordance with various embodiments. In some embodiments, the deep learning system 1000 is a deep neural network (DNN). The deep learning system 1000 trains DNNs for various tasks, including, for example, voice transformation of a throat microphone signal. In the embodiments of FIG. 10, the deep learning system 1000 includes an interface module 1010, a training module 1030, a validation module 1040, a voice transformation system module 1020, and a datastore 1060. In other embodiments, alternative configurations, different or additional components may be included in the deep learning system 1000. Further, functionality attributed to a component of the deep learning system 1000 may be accomplished by a different component included in the deep learning system 1000 or a different module or system, such as any of the neural networks and/or deep learning systems described herein.

In some examples, the deep learning system 1000 includes a lightweight model architecture that is both memory and compute efficient. The model can include a recurrent neural network (RNN). A RNN is a type of artificial neural network that can be used to process sequential data such as audio signals. In some embodiments, the RRN features one or more GRU layers and one or more fully connected layers.

The interface module 1010 facilitates communications of the deep learning system 1000 with other modules or systems. For example, the interface module 1010 establishes communications between the deep learning system 1000 with an external database to receive data that can be used to train DNNs or input into DNNs to perform tasks. As another example, the interface module 1010 supports the deep learning system 1000 to distribute DNNs to other systems, e.g., computing devices configured to apply DNNs to perform tasks.

The training module 1030 trains DNNs by using a training dataset. In some examples, the training dataset includes pairs of spectra obtained from simultaneous recordings of speech utterances, each pair including a spectrum of the signal captured by a throat microphone and a spectrum of the signal captured by a conventional air-conducted microphone. In some examples, the spectra can be log-Mel spectra. In some examples, for each pair, SAS features are extracted from each log-Mel spectrum, and the SAS features are used for training. During training, the DNN learns to map the SAS features of of the signal captured by a throat microphone to the SAS features of the signal captured by the conventional air-conducted microphone. In some examples, the DNN learns a regression mapping between the throat microphone SAS features and the corresponding conventional microphone SAS features.

In an embodiment where the training module 1030 trains a DNN to transform a throat microphone signal, the training module 1030 can compare the SAS features generated by the DNN to the SAS features of the corresponding conventional microphone signal spectrum, which can serve as ground truth. In some embodiments, a part of the training dataset may be used to initially train the DNN, and the rest of the training dataset may be held back as a validation subset used by the validating module 1040 to validate performance of a trained DNN. The portion of the training dataset not including the tuning subset and the validation subset may be used to train the DNN.

The training module 1030 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 3, 30, 300, 400, or even larger.

The training module 1030 defines the architecture of the DNN, e.g., based on some of the hyperparameters. In some examples, the architecture of the DNN includes multiple layers, such as an input layer, an output layer, and a plurality of hidden layers. The input layer of an DNN may include tensors (e.g., a multidimensional array) specifying attributes of the input signal, such as frequency, volume, and other spectral characteristics. The output layer includes labels of angles and/or locations of sound sources in the input layer. The hidden layers are layers between the input layer and output layer. The hidden layers include one or more GRU layers and one or more other types of layers, such as fully connected layers, convolutional layers, pooling layers, normalization layers, SoftMax or logistic layers, and so on. While the DNN described with respect to FIG. 5 is a RNN, in other embodiments, different types of DNNs can be used. In some examples, GRU layers or convolutional layers of the DNN abstract the input signals to perform feature extraction. In some examples, the feature extraction is based on a spectrogram of an input sound signal. A pooling layer can be used to reduce the volume of input signal after convolution. It is used between two convolution layers. A fully connected layer involves weights, biases, and neurons. It connects neurons in one layer to neurons in another layer. It is used to classify signals between different categories by training. Note that training a DNN is different from using the DNN in real-time and when using a DNN to process data that is received in real-time, latency can become an issue that is not present during training, when the data set can be pre-loaded.

In the process of defining the architecture of the DNN, the training module 1030 also adds an activation function to a hidden layer or the output layer. An activation function of a layer transforms the weighted sum of the input of the layer into an output of the layer. The activation function may be, for example, a rectified linear unit activation function, a tangent activation function, or other types of activation functions.

After the training module 1030 defines the architecture of the DNN, the training module 1030 inputs a training dataset into the DNN. The training dataset includes a plurality of training samples. An example of a training sample includes source location of a feature in an audio sample and a ground-truth location of the feature. The training module 1030 modifies the parameters inside the DNN (“internal parameters of the DNN”) to minimize the error between labels of the training features that are generated by the DNN and the ground-truth labels of the features. The internal parameters include weights of filters in the convolutional layers of the DNN. In some embodiments, the training module 1030 uses a cost function to minimize the error.

The training module 1030 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 1030 finishes the predetermined number of epochs, the training module 1030 may stop updating the parameters in the DNN. The DNN having the updated parameters is referred to as a trained DNN.

The validation module 1040 verifies accuracy of trained or compressed DNNs. In some embodiments, the validation module 1040 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 1040 may determine an accuracy score measuring the precision, recall, or a combination of precision and recall of the DNN. The validation module 1040 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validation module 1040 may compare the accuracy score with a threshold score. In an example where the validation module 1040 determines that the accuracy score of the augmented model is less than the threshold score, the validation module 1040 instructs the training module 1030 to re-train the DNN. In one embodiment, the training module 1030 may iteratively re-train the DNN until the occurrence of a stopping condition, such as the accuracy measurement indication that the DNN may be sufficiently accurate, or a number of training rounds having taken place.

The inference module 1050 applies the trained or validated DNN to perform tasks. The inference module 1050 may run inference processes of a trained or validated DNN. In some examples, inference makes use of the forward pass to produce model-generated output for unlabeled real-world data. For instance, the inference module 550 may input real-world data into the DNN and receive an output of the DNN. The output of the DNN may provide a solution to the task for which the DNN is trained for.

The inference module 1050 may aggregate the outputs of the DNN to generate a final result of the inference process. In some embodiments, the inference module 1050 may distribute the DNN to other systems, e.g., computing devices in communication with the deep learning system 1000, for the other systems to apply the DNN to perform the tasks. The distribution of the DNN may be done through the interface module 1010. The computing devices may be connected to the deep learning system 1000 through a network.

In some implementations, the DNN may include a convolution module, which can perform voice transformation. In some examples, the convolution module 1020 can also perform additional real-time data processing, such as for speech enhancement, and/or dynamic noise suppression. The convolution module can include time domain encoder, a frequency domain encoder, and a time domain decoder. In some examples, the time domain encoder is a convolutional time domain encoder, the frequency domain encoder is a convolutional frequency domain spectrum encoder, and the time domain decoder is a convolutional time domain decoder. In other embodiments, alternative configurations, different or additional components may be included in the convolution module. Further, functionality attributed to a component of the convolution module may be accomplished by a different component included in the convolution module, the deep learning system 1000, or a different module or system.

The frequency encoder receives STFT spectra. In various examples, the input data to the frequency encoder is frequency domain STFT spectra derived from input audio data. The input data includes input tensors which can each include multiple frames of data.

In various examples, a STFT is a Fourier-related transform used to determine the sinusoidal frequency and phase content of local sections of a signal as it changes over time. Generally, STFTs are computed by dividing a longer time signal into shorter segments of equal length and then computing the Fourier transform separately on each shorter segment. This results in the Fourier spectrum on each shorter segment. The changing spectra can be plotted as a function of time, for instance as a spectrogram. In some examples, the STFT is a discrete time STFT, such that the data to be transformed is broken up into tensors or frames (which usually overlap each other, to reduce artifacts at the boundary). Each tensor or frame is Fourier transformed, and the complex result is added to a matrix, which records magnitude and phase for each point in time and frequency. In some examples, an input tensor has a size of H×W×C, where H denotes the height of the input tensor (e.g., the number of rows in the input tensor or the number of data elements in a row), W denotes the width of the input tensor (e.g., the number of columns in the input tensor or the number of data elements in a row), and C denotes the depth of the input tensor (e.g., the number of input channels).

An inverse STFT can be generated by inverting the STFT. In various examples, the STFT is processed by the DNN, and it is then inverted at the decoder, or before being input to the decoder. By inverting the STFT, the encoded frequency domain signal from the frequency encoder can be recombined with the encoded time domain signal from the time encoder. One way of inverting the STFT is by using the overlap-add method, which also allows for modifications to the STFT complex spectrum. This makes for a versatile signal processing method, referred to as the overlap and add with modifications method. In various examples, the output from the decoder is an audio output signal representing the input signal for a selected audio source. In some examples, the output from the decoder includes multiple separated audio output signals, each representing the input signal for a respective input audio source.

The datastore 1060 stores data received, generated, used, or otherwise associated with the deep learning system 1000. For example, the datastore 1060 stores the datasets used by the training module 1030 and validation module 1040. The datastore 1060 may also store data such as the hyperparameters for training DNNs, internal parameters of trained DNNs (e.g., weights, etc.), data for sparsity acceleration (e.g., sparsity bitmap, etc.), and so on. In some embodiments the datastore 1060 is a component of the deep learning system 1000. In other embodiments, the datastore 1060 may be external to the deep learning system 1000 and communicate with the deep learning system 1000 through a network.

### Example Computing Device

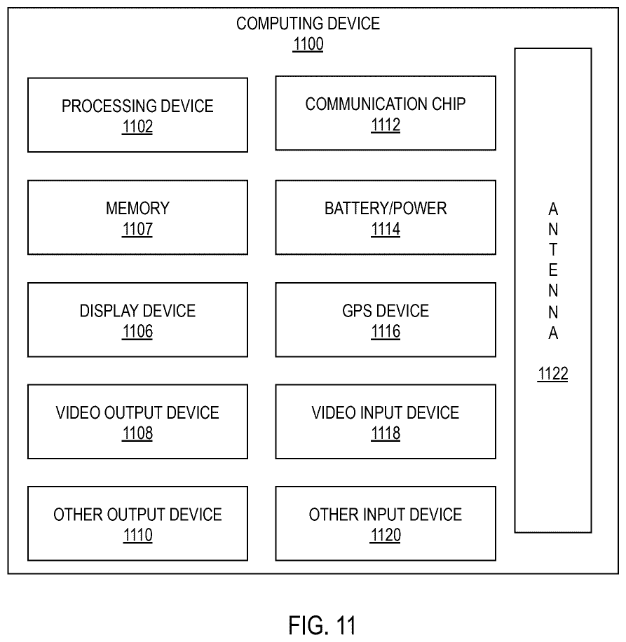

FIG. 11 is a block diagram of an example computing device 1100, in accordance with various embodiments. In some embodiments, the computing device 1100 may be used for at least part of the systems in FIGS. 1, 4, 5, and 6. A number of components are illustrated in FIG. 11 as included in the computing device 1100, but any one or more of these components may be omitted or duplicated, as suitable for the application. In some embodiments, some or all of the components included in the computing device 1100 may be attached to one or more motherboards. In some embodiments, some or all of these components are fabricated onto a single system on a chip (SoC) die. Additionally, in various embodiments, the computing device 1100 may not include one or more of the components illustrated in FIG. 11, but the computing device 1100 may include interface circuitry for coupling to the one or more components. For example, the computing device 1100 may not include a display device 1106, but may include display device interface circuitry (e.g., a connector and driver circuitry) to which a display device 1106 may be coupled. In another set of examples, the computing device 1100 may not include a video input device 1118 or a video output device 1108, but may include video input or output device interface circuitry (e.g., connectors and supporting circuitry) to which a video input device 1118 or video output device 1108 may be coupled.

The computing device 1100 may include a processing device 1102 (e.g., one or more processing devices). The processing device 1102 processes electronic data from registers and/or memory to transform that electronic data into other electronic data that may be stored in registers and/or memory. The computing device 1100 may include a memory 1104, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1104 may include memory that shares a die with the processing device 1102. In some embodiments, the memory 1104 includes one or more non-transitory computer-readable media storing instructions executable for occupancy mapping or collision detection, e.g., the method 900 described above in conjunction with FIG. 9 or some operations performed by the system 100 of FIG. 1, the system 400 of FIG. 4, the mapping neural network 500 of FIG. 5, the system 600 of FIG. 6, the DNN system 1000 in FIG. 10, and/or any other systems discussed herein. The instructions stored in the one or more non-transitory computer-readable media may be executed by the processing device 1102.

In some embodiments, the computing device 1100 may include a communication chip 1112 (e.g., one or more communication chips). For example, the communication chip 1112 may be configured for managing wireless communications for the transfer of data to and from the computing device 1100. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not.

The communication chip 1112 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 812 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 512 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 512 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 512 may operate in accordance with other wireless protocols in other embodiments. The computing device 1100 may include an antenna 1122 to facilitate wireless communications and/or to receive other wireless communications (such as AM or FM radio transmissions).

In some embodiments, the communication chip 1112 may manage wired communications, such as electrical, optical, or any other suitable communication protocols (e.g., the Ethernet). As noted above, the communication chip 1112 may include multiple communication chips. For instance, a first communication chip 1112 may be dedicated to shorter-range wireless communications such as Wi-Fi or Bluetooth, and a second communication chip 1112 may be dedicated to longer-range wireless communications such as global positioning system (GPS), EDGE, GPRS, CDMA, WiMAX, LTE, EV-DO, or others. In some embodiments, a first communication chip 1112 may be dedicated to wireless communications, and a second communication chip 1112 may be dedicated to wired communications.

The computing device 1100 may include battery/power circuitry 1114. The battery/power circuitry 1114 may include one or more energy storage devices (e.g., batteries or capacitors) and/or circuitry for coupling components of the computing device 1100 to an energy source separate from the computing device 1100 (e.g., AC line power).

The computing device 1100 may include a display device 1106 (or corresponding interface circuitry, as discussed above). The display device 1106 may include any visual indicators, such as a heads-up display, a computer monitor, a projector, a touchscreen display, a liquid crystal display (LCD), a light-emitting diode display, or a flat panel display, for example.

The computing device 1100 may include a video output device 1108 (or corresponding interface circuitry, as discussed above). The video output device 1108 may include any device that generates an audible indicator, such as speakers, headsets, or earbuds, for example.

The computing device 1100 may include a video input device 1118 (or corresponding interface circuitry, as discussed above). The video input device 1118 may include any device that generates a signal representative of a sound, such as microphones, microphone arrays, or digital instruments (e.g., instruments having a musical instrument digital interface (MIDI) output).

The computing device 1100 may include a GPS device 1116 (or corresponding interface circuitry, as discussed above). The GPS device 1116 may be in communication with a satellite-based system and may receive a location of the computing device 1100, as known in the art.

The computing device 1100 may include another output device 1110 (or corresponding interface circuitry, as discussed above). Examples of the other output device 1110 may include a video codec, a video codec, a printer, a wired or wireless transmitter for providing information to other devices, or an additional storage device.

The computing device 1100 may include another input device 1120 (or corresponding interface circuitry, as discussed above). Examples of the other input device 1120 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1100 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1100 may be any other electronic device that processes data.

### Select Examples

Example 1 provides an apparatus, including a computer processor for executing computer program instructions; and a non-transitory computer-readable memory storing computer program instructions executable by the computer processor to perform operations including receiving an audio input signal from a throat microphone; extracting smooth average spectrum features and spectrum residual components from the audio input signal; generating, at a neural network, an estimated spectrogram corresponding to an air conduction microphone signal, based on the smooth average spectrum features; adding the spectrum residual components to the estimated spectrogram to generate an enhanced spectrogram; and generating, at a vocoder, an audio output signal based on the enhanced spectrogram.

Example 2 provides the apparatus of example 1, where the neural network is a recurrent neural network, including at least one gated recurrent unit layer and at least one fully connected layer.

Example 3 provides the apparatus of example 2, where the audio input signal includes a plurality of overlapping sequential audio frames, and where the at least one gated recurrent unit layer processes the smooth average spectrum features over time to model temporal dependencies across the sequential audio frames.

Example 4 provides the apparatus of example 3, where the at least one fully connected layer performs nonlinear mapping of the smooth average spectrum features to the estimated spectrogram, based on the temporal dependencies.

Example 5 provides the apparatus of any one of examples 2-4, where the recurrent neural network includes five gated recurrent unit layers followed by five fully connected layers.

Example 6 provides the apparatus of any one of examples 2-5, where the neural network is trained using pairs of spectra obtained from simultaneous recordings of speech utterances, each pair including a spectrum of the signal captured by a throat microphone and a spectrum of the signal captured by a conventional air-conducted microphone.

Example 7 provides the apparatus of any one of examples 1-6, further including generating a plurality of frequency-domain log-mel spectra, each representing a respective time-domain segment of the audio input signal, and where extracting the smooth average spectrum features and spectrum residual components includes modeling each of the plurality of frequency-domain log-mel spectra as a respective original smooth average spectrum and the spectrum residual.

Example 8 provides the apparatus of example 7, where extracting the smooth average spectrum features further includes averaging frequency-domain log-Mel spectra from multiple consecutive time-domain segments of the audio input signal to reduce variability and produce a smooth spectral envelope.

Example 9 provides the apparatus of example 7 or 8, where generating the estimated spectrogram includes generating, at the neural network, a plurality of estimated sum of smooth average spectra, each respective estimated sum of smooth average spectrum based on the corresponding respective original sum of smooth average spectrum; and generating a plurality of updated frequency-domain log-Mel spectra, each updated frequency-domain log-Mel spectrum based on the respective updated sum of smooth average spectrum.

Example 10 provides the apparatus of any one of examples 1-9, where the throat microphone input includes raw vibration-based audio signals captured by a sensor positioned on a speaker's neck.

Example 11 provides the apparatus of any one of examples 1-10, where extracting the smooth average spectrum features includes segmenting the throat microphone signal into overlapping frames using a fixed-length window and applying a windowing function selected from the group consisting of a Hamming function and a Hann function.

Example 12 provides the apparatus of example 11, where extracting the smooth average spectrum features further includes applying a Fast Fourier Transform (FFT) to each frame to generate a magnitude spectrum representing energy distribution across frequencies.

Example 13 provides the apparatus of any one of examples 1-12, where the smooth average spectrum features are normalized using log compression or mean-variance normalization prior to input to the neural network.

Example 14 provides the apparatus of any one of examples 1-13, where the neural network includes a regression neural network including one or more gated recurrent unit layers and one or more fully connected layers.

Example 15 provides the apparatus of example 14, where the gated recurrent unit layers form a recurrent processing stage configured to capture temporal dependencies across sequential audio frames, including phonetic context, coarticulation, and prosody.

Example 16 provides the apparatus of example 15, where the recurrent processing stage includes a multi-layer GRU network including at least five GRU layers.

Example 17 provides the apparatus of any one of examples 14-16, where the fully connected stage includes a plurality of dense layers configured to perform nonlinear mapping from context-enriched hidden states to frequency-domain targets at selected Mel bands.

Example 18 provides the apparatus of example 17, where the fully connected stage includes between two and eight dense layers and optionally includes residual skip connections.

Example 19 provides the apparatus of any one of examples 1-18, where adding the spectrum residual components to the estimated spectrogram includes additive fusion performed as element-wise addition.

Example 20 provides the apparatus of any one of examples 1-19, where adding the spectrum residual components to the estimated spectrogram includes gated fusion performed as a weighted combination of elements.

Example 21 provides the apparatus of any one of examples 1-20, where the vocoder is a log-Mel vocoder configured to synthesize an audio waveform from the reconstructed log-Mel spectrogram.

Example 22 provides the apparatus of example 21, where the audio output signal approximates natural speech recorded with a conventional microphone and improves intelligibility for human listeners and speech recognition systems.

Example 23 provides one or more non-transitory computer-readable media storing instructions executable to perform operations, the operations including receiving an audio input signal from a throat microphone; extracting smooth average spectrum features and spectrum residual components from the audio input signal; generating, at a neural network, an estimated spectrogram corresponding to an air conduction microphone signal, based on the smooth average spectrum features; adding the spectrum residual components to the estimated spectrogram to generate an enhanced spectrogram; and generating, at a vocoder, an audio output signal based on the enhanced spectrogram.

Example 24 provides the one or more non transitory computer readable media of example 23, where the neural network is a recurrent neural network including at least one gated recurrent unit (GRU) layer and at least one fully connected layer.

Example 25 provides the one or more non transitory computer readable media of example 24, where the audio input signal includes a plurality of overlapping sequential audio frames, and where executing the instructions causes the at least one GRU layer to process the smooth average spectrum features over time to model temporal dependencies across the sequential audio frames.

Example 26 provides the one or more non transitory computer readable media of example 25, where executing the instructions causes the at least one fully connected layer to perform nonlinear mapping of the smooth average spectrum features to the estimated spectrogram based on the temporal dependencies.

Example 27 provides the one or more non transitory computer readable media of any one of examples 24-26, where the recurrent neural network includes five GRU layers followed by five fully connected layers.

Example 28 provides the one or more non transitory computer readable media of any one of examples 24-27, where executing the instructions further includes training the neural network using pairs of spectra obtained from simultaneous recordings of speech utterances, each pair including a spectrum of a signal captured by a throat microphone and a spectrum of a signal captured by a conventional air conducted microphone.

Example 29 provides the one or more non transitory computer readable media of any one of examples 23-28, the instructions further executable to generate a plurality of frequency domain log Mel spectra, each representing a respective time domain segment of the audio input signal, and where extracting the smooth average spectrum features and spectrum residual components includes modeling each of the plurality of frequency domain log Mel spectra as a respective original smooth average spectrum and a spectrum residual.

Example 30 provides the one or more non transitory computer readable media of example 29, where extracting the smooth average spectrum features further includes averaging frequency domain log Mel spectra from multiple consecutive time domain segments of the audio input signal to reduce variability and produce a smooth spectral envelope.

Example 31 provides the one or more non transitory computer readable media of example 29 or 30, where generating the estimated spectrogram includes (i) generating, at the neural network, a plurality of estimated smooth average spectra, each respective estimated smooth average spectrum based on a corresponding respective original smooth average spectrum, and (ii) generating a plurality of updated frequency domain log Mel spectra, each updated frequency domain log Mel spectrum based on the respective estimated smooth average spectrum.

Example 32 provides the one or more non transitory computer readable media of any one of examples 23-31, where the throat microphone input includes raw vibration based audio signals captured by a sensor positioned on a speaker's neck.

Example 33 provides the one or more non transitory computer readable media of any one of examples 23-32, where extracting the smooth average spectrum features includes segmenting the throat microphone signal into overlapping frames using a fixed length window and applying a windowing function selected from the group consisting of a Hamming function and a Hann function.

Example 34 provides the one or more non transitory computer readable media of example 33, where extracting the smooth average spectrum features further includes applying a Fast Fourier Transform (FFT) to each frame to generate a magnitude spectrum representing energy distribution across frequencies.

Example 35 provides the one or more non transitory computer readable media of any one of examples 23-34, where the smooth average spectrum features are normalized using log compression or mean variance normalization prior to input to the neural network.

Example 36 provides the one or more non transitory computer readable media of any one of examples 23-35, where the neural network includes a regression neural network including one or more GRU layers and one or more fully connected layers.

Example 37 provides the one or more non transitory computer readable media of example 36, where the GRU layers form a recurrent processing stage configured to capture temporal dependencies across sequential audio frames, including phonetic context, coarticulation, and prosody.

Example 38 provides the one or more non transitory computer readable media of example 37, where the recurrent processing stage includes a multi layer GRU network including at least five GRU layers.

Example 39 provides the one or more non transitory computer readable media of any one of examples 36-38, where the fully connected stage includes a plurality of dense layers configured to perform nonlinear mapping from context enriched hidden states to frequency domain targets at selected Mel bands.

Example 40 provides the one or more non transitory computer readable media of example 39, where the fully connected stage includes between two and eight dense layers and optionally includes residual skip connections.

Example 41 provides the one or more non transitory computer readable media of any one of examples 23-40, where adding the spectrum residual components to the estimated spectrogram includes additive fusion performed as element wise addition.

Example 42 provides the one or more non transitory computer readable media of any one of examples 23-41, where adding the spectrum residual components to the estimated spectrogram includes gated fusion performed as a weighted combination of elements.

Example 43 provides the one or more non transitory computer readable media of any one of examples 23-42, where the vocoder is a log Mel vocoder configured to synthesize an audio waveform from the enhanced spectrogram.

Example 44 provides the one or more non transitory computer readable media of example 43, where the audio output signal approximates natural speech recorded with a conventional microphone and improves intelligibility for human listeners and speech recognition systems.

Example 45 provides a computer implemented method, including receiving an audio input signal from a throat microphone; extracting smooth average spectrum features and spectrum residual components from the audio input signal; generating, at a neural network, an estimated spectrogram corresponding to an air conduction microphone signal based on the smooth average spectrum features; adding the spectrum residual components to the estimated spectrogram to generate an enhanced spectrogram; and generating, at a vocoder, an audio output signal based on the enhanced spectrogram.

Example 46 provides the method of example 45, where the neural network is a recurrent neural network including at least one gated recurrent unit (GRU) layer and at least one fully connected layer.

Example 47 provides the method of example 46, where the audio input signal includes a plurality of overlapping sequential audio frames, and where the at least one GRU layer processes the smooth average spectrum features over time to model temporal dependencies across the sequential audio frames.

Example 48 provides the method of example 47, where the at least one fully connected layer performs nonlinear mapping of the smooth average spectrum features to the estimated spectrogram based on the temporal dependencies.

Example 49 provides the method of any one of examples 46-48, where the recurrent neural network includes five GRU layers followed by five fully connected layers.

Example 50 provides the method of any one of examples 46-49, further including training the neural network using pairs of spectra obtained from simultaneous recordings of speech utterances, each pair including a spectrum of a signal captured by a throat microphone and a spectrum of a signal captured by a conventional air conduction microphone.

Example 51 provides the method of any one of examples 45-50, further including generating a plurality of frequency domain log Mel spectra, each representing a respective time domain segment of the audio input signal, and where extracting the smooth average spectrum features and spectrum residual components includes modeling each of the plurality of frequency domain log Mel spectra as a respective smooth average spectrum and a spectrum residual.

Example 52 provides the method of example 51, where extracting the smooth average spectrum features further includes averaging frequency domain log Mel spectra from multiple consecutive time domain segments of the audio input signal to reduce variability and produce a smooth spectral envelope.

Example 53 provides the method of example 51 or 52, where generating the estimated spectrogram includes (i) generating, at the neural network, a plurality of estimated smooth average spectra, each respective estimated smooth average spectrum based on a corresponding respective smooth average spectrum of the audio input signal; and (ii) generating a plurality of updated frequency domain log Mel spectra, each updated frequency domain log Mel spectrum based on the respective estimated smooth average spectrum.

Example 54 provides the method of any one of examples 45-53, where receiving the audio input signal includes receiving raw vibration based audio signals captured by a sensor positioned on a speaker's neck.

Example 55 provides the method of any one of examples 45-54, where extracting the smooth average spectrum features includes segmenting the throat microphone signal into overlapping frames using a fixed length window and applying a windowing function selected from the group consisting of a Hamming function and a Hann function.

Example 56 provides the method of example 55, where extracting the smooth average spectrum features further includes applying a Fast Fourier Transform (FFT) to each frame to generate a magnitude spectrum representing energy distribution across frequencies.

Example 57 provides the method of any one of examples 45-56, further including normalizing the smooth average spectrum features using log compression or mean variance normalization prior to providing the smooth average spectrum features to the neural network.

Example 58 provides the method of any one of examples 45-57, where the neural network includes a regression neural network including one or more GRU layers and one or more fully connected layers.

Example 59 provides the method of example 58, where the one or more GRU layers form a recurrent processing stage configured to capture temporal dependencies across sequential audio frames, including phonetic context, coarticulation, and prosody.

Example 60 provides the method of example 59, where the recurrent processing stage includes a multi layer GRU network including at least five GRU layers.

Example 61 provides the method of any one of examples 58-60, where the fully connected stage includes a plurality of dense layers configured to perform nonlinear mapping from context enriched hidden states to frequency domain targets at selected Mel bands.

Example 62 provides the method of example 61, where the fully connected stage includes between two and eight dense layers and optionally includes residual skip connections.

Example 63 provides the method of any one of examples 45-62, where adding the spectrum residual components to the estimated spectrogram includes additive fusion performed as element wise addition.

Example 64 provides the method of any one of examples 45-63, where adding the spectrum residual components to the estimated spectrogram includes gated fusion performed as a weighted combination of elements.

Example 65 provides the method of any one of examples 45-64, where the vocoder is a log Mel vocoder configured to synthesize an audio waveform from the enhanced spectrogram.

Example 66 provides the method of example 65, where the audio output signal approximates natural speech recorded with a conventional microphone and improves intelligibility for human listeners and speech recognition systems.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

What is claimed is:

1. An apparatus, comprising:
a computer processor for executing computer program instructions; and
a non-transitory computer-readable memory storing computer program instructions executable by the computer processor to perform operations comprising:
receiving an audio input signal from a throat microphone;
extracting smooth average spectrum features and spectrum residual components from the audio input signal;
generating, at a neural network, an estimated spectrogram corresponding to an air conduction microphone signal, based on the smooth average spectrum features;
adding the spectrum residual components to the estimated spectrogram to generate an enhanced spectrogram; and
generating, at a vocoder, an audio output signal based on the enhanced spectrogram.

2. The apparatus of claim 1, wherein the neural network is a recurrent neural network, including at least one gated recurrent unit layer and at least one fully connected layer.

3. The apparatus of claim 2, wherein the audio input signal includes a plurality of overlapping sequential audio frames, and wherein the at least one gated recurrent unit layer processes the smooth average spectrum features over time to model temporal dependencies across the sequential audio frames.

4. The apparatus of claim 3, wherein the at least one fully connected layer performs nonlinear mapping of the smooth average spectrum features to the estimated spectrogram, based on the temporal dependencies.

5. The apparatus of claim 2, wherein the neural network is trained using pairs of spectra obtained from simultaneous recordings of speech utterances, each pair including a spectrum of a signal captured by a throat microphone and a spectrum of a signal captured by a conventional air-conducted microphone.

6. The apparatus of claim 1, further comprising generating a plurality of frequency-domain log-mel spectra, each representing a respective time-domain segment of the audio input signal, and wherein extracting the smooth average spectrum features and spectrum residual components includes modelling each of the plurality of frequency-domain log-mel spectra as a respective original smooth average spectrum and the spectrum residual component.

7. The apparatus of claim 6, wherein extracting the smooth average spectrum features further comprises averaging frequency-domain log-mel spectra from multiple consecutive time-domain segments of the audio input signal to reduce variability and produce a smooth spectral envelope.

8. The apparatus of claim 6, wherein generating the estimated spectrogram includes:
generating, at the neural network, a plurality of estimated smooth average spectra, each respective estimated smooth average spectrum based on a corresponding respective original smooth average spectrum; and
generating a plurality of updated frequency-domain log-Mel spectra, each updated frequency-domain log-Mel spectrum based on the respective updated smooth average spectrum.

9. One or more non-transitory computer-readable media storing instructions executable to perform operations, the operations comprising:
receiving an audio input signal from a throat microphone;
extracting smooth average spectrum features and spectrum residual components from the audio input signal;
generating, at a neural network, an estimated spectrogram corresponding to an air conduction microphone signal, based on the smooth average spectrum features;
adding the spectrum residual components to the estimated spectrogram to generate an enhanced spectrogram; and
generating, at a vocoder, an audio output signal based on the enhanced spectrogram.

10. The one or more non-transitory computer-readable media of claim 9, wherein the neural network is a recurrent neural network, including at least one gated recurrent unit layer and at least one fully connected layer.

11. The one or more non-transitory computer-readable media of claim 10, wherein the audio input signal includes a plurality of overlapping sequential audio frames, and wherein the at least one gated recurrent unit layer processes the smooth average spectrum features over time to model temporal dependencies across the sequential audio frames.

12. The one or more non-transitory computer-readable media of claim 11, wherein the at least one fully connected layer performs nonlinear mapping of the smooth average spectrum features to the estimated spectrogram, based on the temporal dependencies.

13. The one or more non-transitory computer-readable media of claim 11, wherein the neural network is trained using pairs of spectra obtained from simultaneous recordings of speech utterances, each pair including a spectrum of the signal captured by a throat microphone and a spectrum of the signal captured by a conventional air-conducted microphone.

14. The one or more non-transitory computer-readable media of claim 9, the operations further comprising generating a plurality of frequency-domain log-mel spectra, each representing a respective time-domain segment of the audio input signal, and wherein extracting the smooth average spectrum features and spectrum residual components includes modelling each of the plurality of frequency-domain log-mel spectra as a respective original smooth average spectrum and the spectrum residual.

15. The one or more non-transitory computer-readable media of claim 14, wherein extracting the smooth average spectrum features further comprises averaging frequency-domain log-mel spectra from multiple consecutive time-domain segments of the audio input signal to reduce variability and produce a smooth spectral envelope.

16. The one or more non-transitory computer-readable media of claim 14, wherein generating the estimated spectrogram includes:
generating, at the neural network, a plurality of estimated smooth average spectra, each respective estimated smooth average spectrum based on a corresponding respective original smooth average spectrum; and
generating a plurality of updated frequency-domain log-Mel spectra, each updated frequency-domain log-Mel spectrum based on the respective updated smooth average spectrum.

17. A computer-implemented method for voice transformation, comprising:
receiving an audio input signal from a throat microphone;
extracting smooth average spectrum features and spectrum residual components from the audio input signal;
generating, at a neural network, an estimated spectrogram corresponding to an air conduction microphone signal, based on the smooth average spectrum features;
adding the spectrum residual components to the estimated spectrogram to generate an enhanced spectrogram; and
generating, at a vocoder, an audio output signal based on the enhanced spectrogram.

18. The computer-implemented method according to claim 17, wherein the neural network is a recurrent neural network, including at least one gated recurrent unit layer and at least one fully connected layer.

19. The computer-implemented method according to claim 18, wherein the audio input signal includes a plurality of overlapping sequential audio frames, and wherein the at least one gated recurrent unit layer processes the smooth average spectrum features over time to model temporal dependencies across the sequential audio frames.

20. The computer-implemented method according to claim 19, wherein the at least one fully connected layer performs nonlinear mapping of the smooth average spectrum features to the estimated spectrogram, based on the temporal dependencies.
